(19) United States
(12) Patent Application Publication
(10) Pub. No.: US 2019/0213819 A1
(43) Pub. Date: Jul. 11, 2019

(54) MANAGEMENT DEVICE, CONTROL METHOD, AND PROGRAM

(71) Applicant: Connected Design, Inc., Tokyo (JP)

(72) Inventors: Yuki TERASHIMA, Tokyo (JP); Toru TAKAGI, Tokyo (JP); Junichi SUZUKI, Tokyo (JP); Yoshihiro SASAGO, Tokyo (JP); Takehiro HAYASHIDA, Tokyo (JP)

(73) Assignee: Connected Design, Inc., Tokyo (JP)

(21) Appl. No.: 16/307,752

(22) PCT Filed: Aug. 10, 2016
(86) PCT No.: PCT/JP2016/073541

§ 371 Date: Dec. 6, 2018

(30) Foreign Application Priority Data
Jun. 7, 2016 (JP) 2016-113622

(51) Int. Cl. G07C 9/00; G06Q 10/02

(52) U.S. Cl. CPC G07C 9/00904; G07C 9/00103; G07C 9/00571; G06Q 10/02

(57) ABSTRACT

Management device 100 includes reservation receiver 103 that receives reservation conditions including an identifier for identifying network appliance 10 that can be electrically controlled through a communication network and reservation time information indicating a time of controlling network appliance 10, that generates reservation information based on the reservation conditions, and that outputs address information for accessing a user screen corresponding to the reservation information that is generated; usability determiner 104 that determines usability of network appliance 10 based on the reservation information, when an instruction to operate network appliance 10 is issued from the user screen that is accessed by using the address information; and appliance controller 105 that controls network appliance 10 based on the instruction, in a case where the usability determiner determines that network appliance 10 is usable.

### TECHNICAL FIELD

The present invention relates to a management device, a control method, and a program, and more specifically, to a management device, a control method, and a program for controlling an electronic appliance through a communication network.

### BACKGROUND ART

In recent years, the Internet of Things (IoT) has been gaining attention. The IoT is a system which enables a higher level of control based on exchange of information among all types of objects, such as vehicles, home appliances, medical appliances, robots and sensors, which are connected to the Internet.

For example, in a system disclosed in Patent Literature 1, all types of electronic appliances at home are connected to the Internet through a gateway at home, and electronic appliances can be controlled by a terminal device such as a smartphone. In this case, as electronic appliances which are connected to the Internet, lights, air conditioners, TVs, robot cleaners, washing machines, microwave ovens, refrigerators and the like are cited.

When electronic appliances at home are connected to the Internet, control of electronic appliances at home from outside is enabled, and lives of people are possibly drastically changed. For example, it takes time for a comfortable room temperature to be reached after an air conditioner is switched on, but if the air conditioner is connected to the Internet, the air conditioner can be remotely operated and switched on from outside before one returns home. With such a system, in the interest of security, people who are allowed to perform remote operation are limited to people who are registered in advance, such as the owner of the house.

### CITATION LIST

### Patent Literature

Patent Literature 1: JP2016-38777A

### SUMMARY OF INVENTION

### Technical Problem

With a system as described in Patent Literature 1, control of an electronic appliance which is connected to the Internet, by a terminal device, is not restricted by an external system. Accordingly, there is a problem in which once a terminal device for remotely operating an electronic appliance is registered, the electronic appliance cannot be remotely operated by terminal devices other than the registered terminal device. For example, an electronic appliance installed at a facility for common use cannot be remotely operated by other than the registered terminal device.

The present invention has its object to provide a management device, a control method, and a program for solving the problem described above.

### Solution to Problem

A management device according to the present invention includes a reservation receiver that receives reservation conditions including an identifier for identifying a network appliance that can be electrically controlled through a communication network and reservation time information indicating a time of controlling the network appliance, that generates reservation information based on the reservation conditions, and that outputs address information for accessing a user screen corresponding to the reservation information that is generated; a usability determiner that determines usability of the network appliance based on the reservation information, when an instruction to operate the network appliance is issued from the user screen that is accessed by using the address information; and an appliance controller that controls the network appliance based on the instruction, in a case where the usability determiner determines that the network appliance is usable.

A control method according to the present invention includes the steps of receiving reservation conditions including an identifier for identifying a network appliance that can be electrically controlled through a communication network and reservation time information indicating a time of controlling the network appliance, and generating reservation information based on the reservation conditions; outputting address information for accessing a user screen corresponding to the reservation information that is generated; determining usability of the network appliance based on the reservation information, when an instruction to operate the network appliance is issued from the user screen that is accessed by using the address information; and controlling the network appliance based on the instruction, in a case where the network appliance is determined to be usable.

A program according to the present invention causes a computer to perform the steps of receiving reservation conditions including an identifier for identifying a network appliance that can be electrically controlled through a communication network and reservation time information indicating a time of controlling the network appliance, and generating reservation information based on the reservation conditions; outputting address information for accessing a user screen corresponding to the reservation information that is generated; determining usability of the network appliance based on the reservation information, when an instruction to operate the network appliance is issued from the user screen that is accessed by using the address information; and controlling the network appliance based on the instruction, in a case where the network appliance is determined to be usable.

### Advantageous Effects of Invention

According to the present invention, an electronic appliance which is connected to the Internet can be controlled in coordination with an external system, and control by a terminal device which is allowed temporal use is enabled.

### BRIEF DESCRIPTION OF DRAWINGS

FIG. 1 is a diagram showing a configuration of management system 1 of the present invention.

FIG. 2 is a diagram showing a functional configuration of management device 100 according to a first embodiment of the present invention.

FIG. 3 is a diagram for describing an example of a data structure of an appliance database.

FIG. 4 is a diagram for describing an example of a data structure of a reservation database.

FIG. 5 is a diagram showing an example of a user screen.

FIG. 6 is a diagram showing an example of the user screen.

FIG. 7 is a diagram showing an example of a management screen.

FIG. 8 is a diagram showing an example of the management screen.

FIG. 9 is a diagram showing an example of a user screen in a case of performing user registration.

FIG. 10 is a sequence diagram for describing facility reservation and unlock operations.

FIG. 11 is a sequence diagram for describing an operation related to a manager screen.

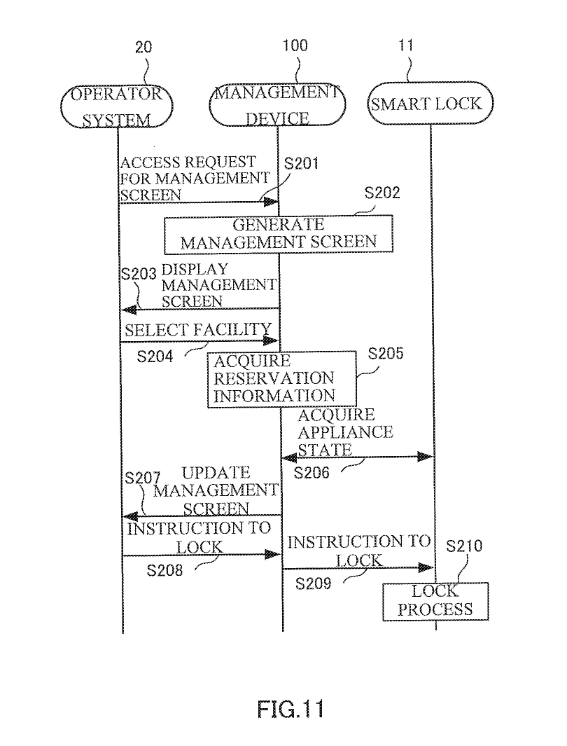

FIG. 12 is a diagram showing a functional configuration of management device 200 according to a second embodiment of the present invention.

FIG. 13 is a diagram for describing an example of a data structure of an appliance database.

FIG. 14 is a diagram for describing an example of a data structure of a reservation database.

FIG. 15 is a diagram showing an example of a user screen.

FIG. 16 is a diagram showing an example of a management screen including a camera image.

FIG. 17 is a diagram showing an example of hardware configuration of the management device.

### DESCRIPTION OF EMBODIMENTS

Hereinafter, embodiments of the present invention will be described with reference to the appended drawings. Additionally, in the present specification and drawings, structural elements having the same function may be denoted by the same reference sign, and redundant description thereof may be omitted.

<System Configuration>

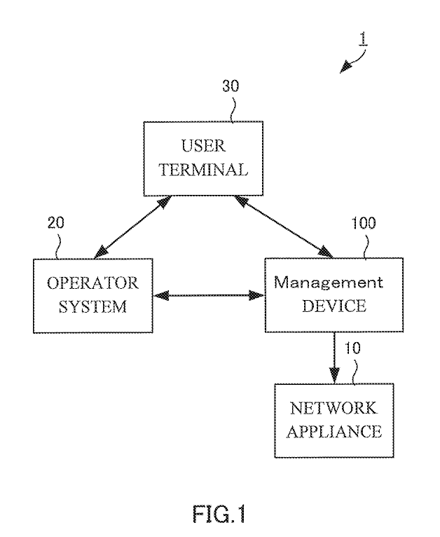

FIG. 1 shows an overall configuration of management system 1 according to an embodiment of the present invention. Management system 1 includes network appliance 10 as a reservation target appliance, management device 100, operator system 20, and user terminal 30. Network appliance 10, management device 100, operator system 20, and user terminal 30 are each connected to a communication network.

Network appliance 10 is an electronic appliance which is connected to a communication network, and can be remotely operated through a communication network such as the Internet. In the present specification, network appliance 10 is any object which is connected to the communication network, such as a smart lock, a sensor, a camera, a light, a smart plug, an air conditioner or a home appliance controller, and may be collectively referred to as an IoT appliance. Network appliance 10 may be operated by being controlled through the communication network or by being controlled by other controllers. Network appliance 10 is also able to issue a notification regarding its own state.

Management device 100 is a server which provides a function for enabling use of network appliance 10 by a user other than the owner. As a function to be provided by management device 100, there is an application programming interface (API) defining a procedure, a data format and the like for allowing use by other computer programs. When invoked by another computer program in accordance with an API reference, management device 100 performs a predetermined process and returns a processing result to an invocation source.

Operator system 20 is a system which provides a service that uses the function provided by management device 100. Operator system 20 transmits, to management device 100, a request according to the API reference provided by management device 100, and receives a processing result from management device 100.

User terminal 30 is a terminal device of a user who uses the service provided by operator system 20. For example, user terminal 30 is a device which is capable of connecting to the Internet, such as a smartphone, a tablet terminal, or a personal computer (PC).

### First Embodiment

(Functional Configuration of Management Device 100)

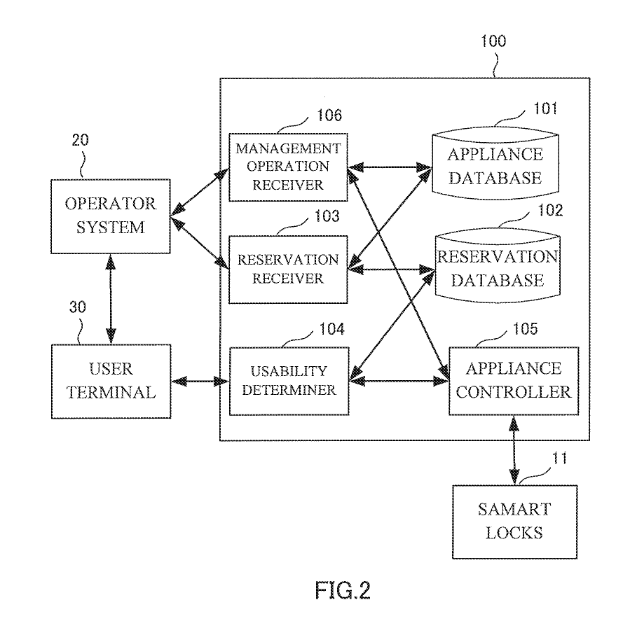

FIG. 2 is a diagram showing a functional configuration of management device 100 according to a first embodiment of the present invention. Additionally, in the following description, a case where network appliance 10 is smart lock 11 is described. In this example, management device 100 provides a function of managing reservation information regarding a facility where smart lock 11 is installed, and of controlling smart lock 11 based on the reservation information. Operator system 20 uses the function provided by management device 100, and provides a service for enabling a user to use the facility where smart lock 11 is installed for a specific period of time. For example, operator system 20 provides a function of authorizing a user for a specific period of time to open/close smart lock 11, in order to provide a service such as private viewing of real estate, private accommodation, a shared office, a housekeeping service, or a visiting care.

Smart lock 11 is used by being installed at a door of a facility. Smart lock 11 is an electronic lock, an electrical lock or the like that can be operated by electrical signals, and is capable of unlocking or locking the door. Smart lock 11 may be unlocked or locked by operation of an operation unit provided at a housing of the smart lock or by using a key such as a card key. Smart lock 11 is connected to the Internet, and is controlled through the Internet. That is, smart lock 11 can be electrically controlled through the communication network. For example, smart lock 11 is wirelessly connected to an interface appliance, not shown, provided in the facility, and is connected to the Internet through the interface appliance.

Management device 100 includes appliance database 101, reservation database 102, reservation receiver 103, usability determiner 104, appliance controller 105, and management operation receiver 106. In FIG. 2, one smart lock 11, one operator system 20, and one user terminal 30 are shown, but management device 100 may be connected through the Internet to a plurality of smart locks 11, a plurality of operator systems 20, and a plurality of user terminals 30.

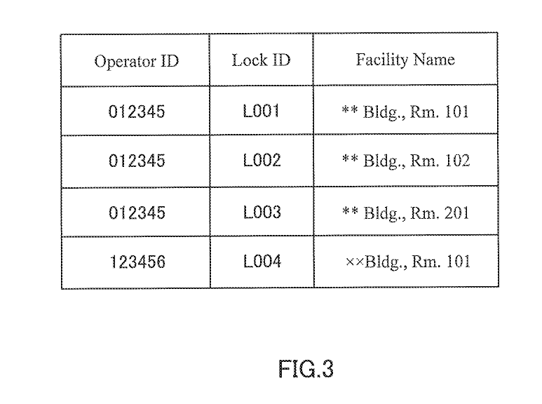

Appliance database 101 stores information about an operator operating operator system 20, and about network appliance 10 associated with the operator. For example, as shown in FIG. 3, appliance database 101 stores an operator ID (Identifier), which is an identifier for identifying an operator, and a lock ID, which is an identifier for identifying smart lock 11. Appliance database 101 may also include a facility name, which is the name of a facility where smart lock 11 to be identified by the lock ID is installed. Additionally, in this case, smart lock 11 is indicated as network appliance 10, but appliance database 101 may include information about network appliance 10 other than smart lock 11.

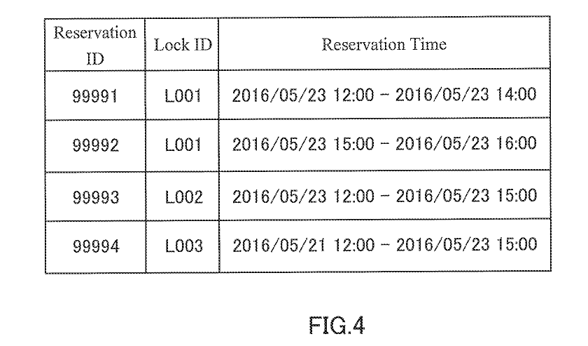

Reservation database 102 stores reservation information generated based on reservation conditions, received from operator system 20, including the lock ID and reservation time information. For example, as shown in FIG. 4, reservation database 102 includes, as the reservation information, a reservation ID, which is an identifier for identifying each reservation, the lock ID for identifying smart lock 11 which is provided at a reservation target facility, and information about a reservation time indicating a time when smart lock 11 is controlled in relation to the reservation.

Reservation receiver 103 generates reservation information about control of smart lock 11 based on the reservation conditions received from operator system 20, and causes the reservation information to be stored in reservation database 102. Reservation receiver 103 generates a uniform resource locator (URL), which is address information for accessing a user screen corresponding to the generated reservation information, and outputs the generated URL to operator system 20. The user screen is an operation screen which a user of user terminal 30 uses to operate smart lock 11.

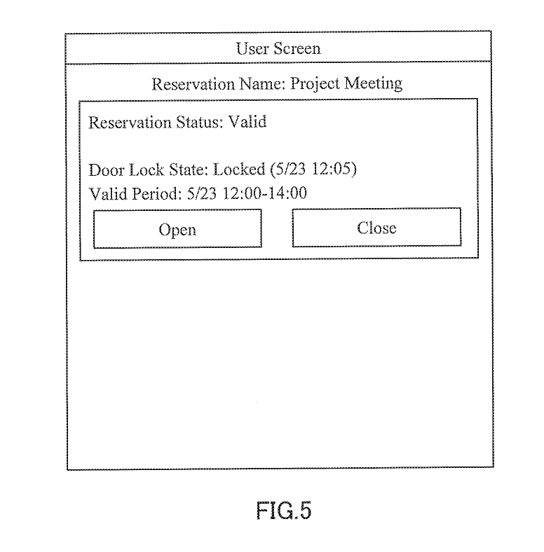

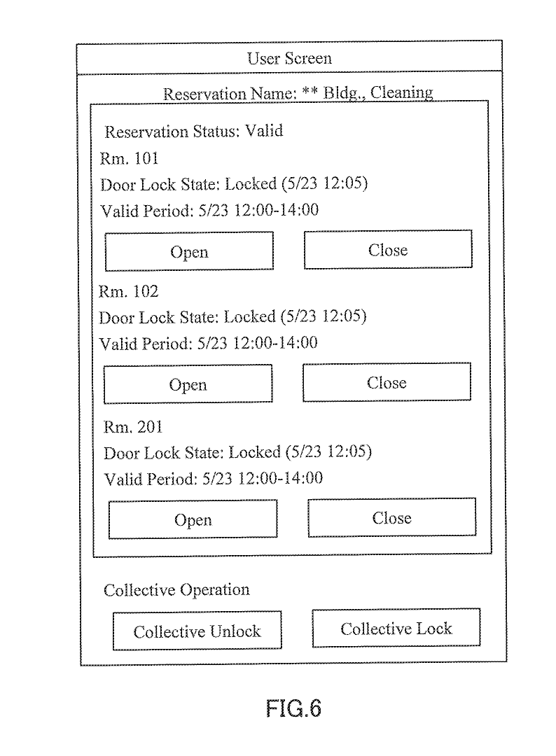

Usability determiner 104 receives access which is based on the URL output from reservation receiver 103, and determines usability of smart lock 11 based on the reservation information stored in reservation database 102. Usability determiner 104 generates the user screen based on a determination result regarding usability, and causes the generated user screen to be displayed by user terminal 30. FIG. 5 shows an example of the user screen. The user screen includes, with respect to corresponding reservation information, a period of time when smart lock 11 can be controlled, an open/close state of smart lock 11, and operation buttons for issuing instructions regarding an opening/closing operation of smart lock 11. FIG. 6 shows an example of the user screen in a case where a plurality of smart locks 11 are associated with one piece of reservation information. In the case where a plurality of smart locks 11 are associated with one piece of reservation information, the user screen may include operation buttons for opening/closing each of the plurality of smart locks 11, and a collective unlock button and a collective lock button for collectively opening/closing the plurality of smart locks 11. When an operation instruction for smart lock 11 is received from user terminal 30 through the user screen, usability determiner 104 again determines the usability, and in the case of determining that use is allowed, usability determiner 104 instructs appliance controller 105 to control smart lock 11.

In the case where usability determiner 104 determines that smart lock 11 is usable, appliance controller 105 controls smart lock 11 based instructions from user terminal 30. Furthermore, appliance controller 105 controls smart lock 11 based on instructions from management operation receiver 106.

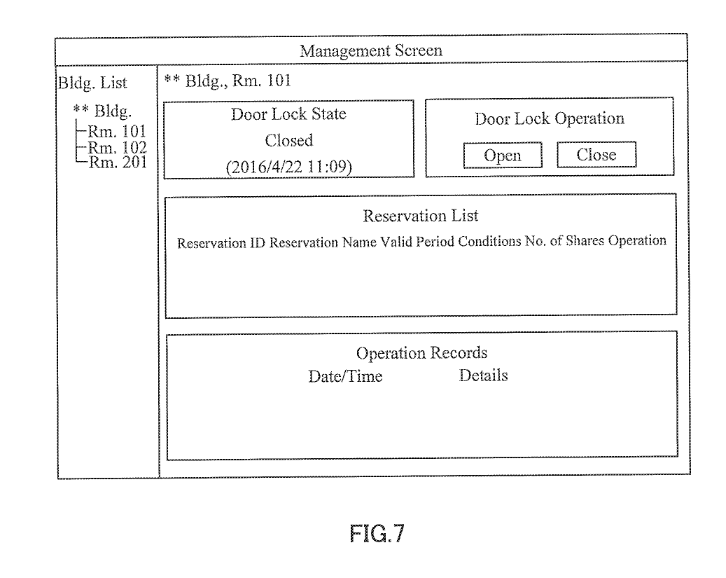

Management operation receiver 106 generates and outputs a management screen which is used by the operator operating operator system 20 to manage smart lock 11. An example of the management screen is shown in FIG. 7. The operator can access the management screen by using the operator ID. The management screen includes a list of facility names which are associated with the operator ID. When one facility is selected from the list, the state of door lock of the selected facility, a reservation list for the facility, and an operation record of corresponding smart lock 11 are displayed on the management screen. Furthermore, smart lock 11 may be opened or closed by operating of an “open” button or a “close” button on the management screen. FIG. 2 will be described again. To display the list of facility names shown in FIG. 7, management operation receiver 106 acquires facility names which are associated with the operator ID from appliance database 101. To display the state of door lock shown in FIG. 7, management operation receiver 106 causes appliance controller 105 to acquire the state of smart lock 11, when access to the management screen is received. To display the reservation list shown in FIG. 7, management operation receiver 106 acquires, from reservation database 102, the reservation information which is associated with corresponding smart lock 11.

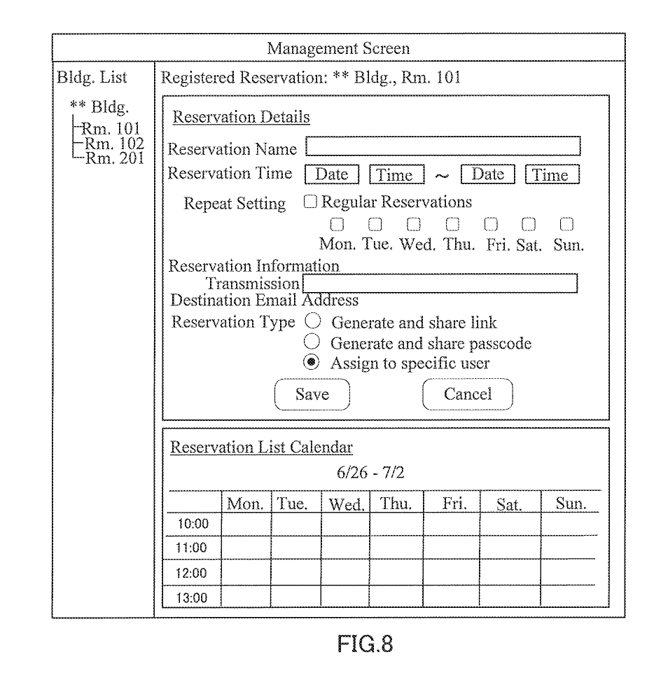

Management operation receiver 106 may also generate a management screen having a reservation registration function as shown in FIG. 8. By providing the reservation registration function on the management screen provided by management device 100, operator system 20 does not have to implement the reservation registration function to be used by the operator for management. With the reservation registration function provided on the management screen, three types of reservation methods, i.e., “generate and share link”, “generate and share passcode”, and “assign to specific user”, may be selected. Reservation conditions such as a reservation name, a reservation time, repeat setting, reservation information transmission destination email address and the like are input for all these reservation methods. Below a section for inputting the reservation conditions, reservation information which is currently registered is displayed as a calendar. In the case where the reservation method is “generate and share link”, management operation receiver 106 generates a link for accessing the user screen for operating smart lock 11, and shares the link by transmitting the link by an email. This user screen is the same as the user screens shown in FIGS. 5 and 6, for example. In the case where the reservation method is “generate and share passcode”, management operation receiver 106 generates a passcode which is valid at a reservation time in the corresponding reservation information, and transmits the passcode by an email. The passcode is a number for unlocking smart lock 11. Smart lock 11 can be unlocked by inputting the passcode by using the operation unit provided on a front surface of the housing of smart lock 11.

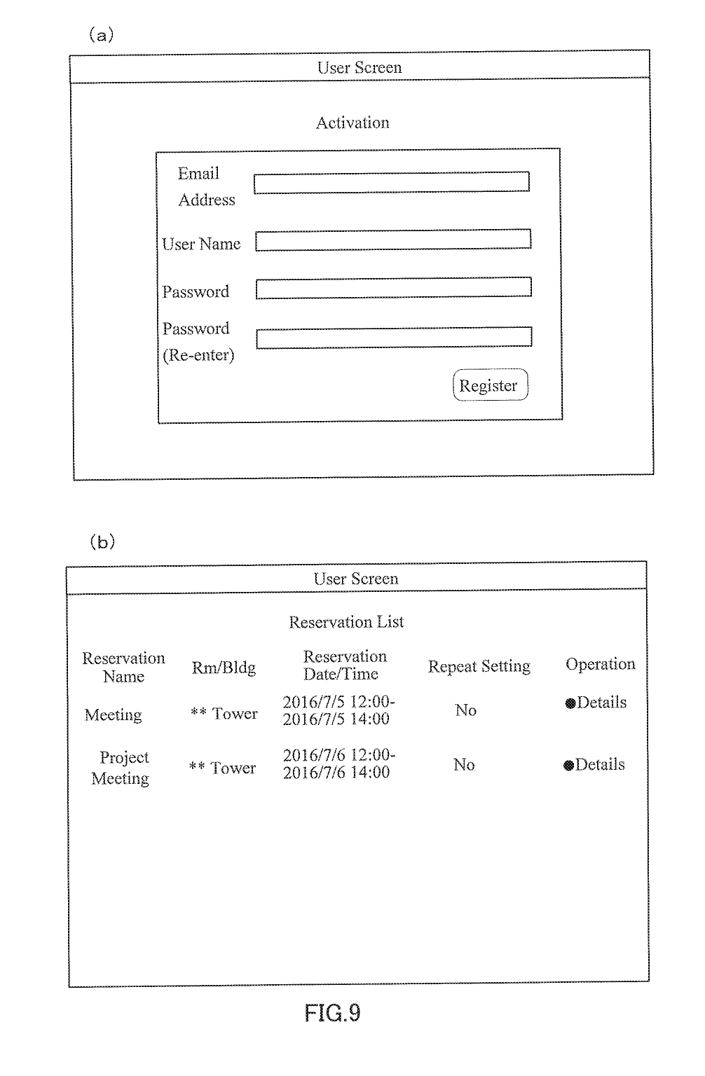

In the case where the reservation method is “assign to specific user”, management operation receiver 106 generates a user registration screen for making a user perform user registration, and transmits an URL for accessing the user registration screen by email. FIG. 9(a) shows an example of the user registration screen. Input of user information which is used for performing user registration, such as an email address, a user name and a password, is received on the user registration screen, and unique identification of the corresponding user is enabled in management system 1. FIG. 9(b) shows an example of the user screen which is displayed after the user is logged in, by using a password and identification information, such as the user name and the email address, for identifying the user. In the case where the reservation methods are “generate and share link” and “generate and share passcode”, the user cannot be identified, and thus, if the link to the user screen and the passcode are transferred, anyone can operate smart lock 11. On the other hand, the present reservation method enables identification of the user, and thus, a person who operates smart lock 11 can be restricted to a user who is logged in. Furthermore, with the present reservation method, in the case where a plurality of reservations are made by a user, the plurality of reservations may be displayed in a list on the screen after login (FIG. 9(b)). Accordingly, an email in which the URL for accessing the user screen is described does not have to be saved, and user convenience is increased.

(Example Operation of Management System 1)

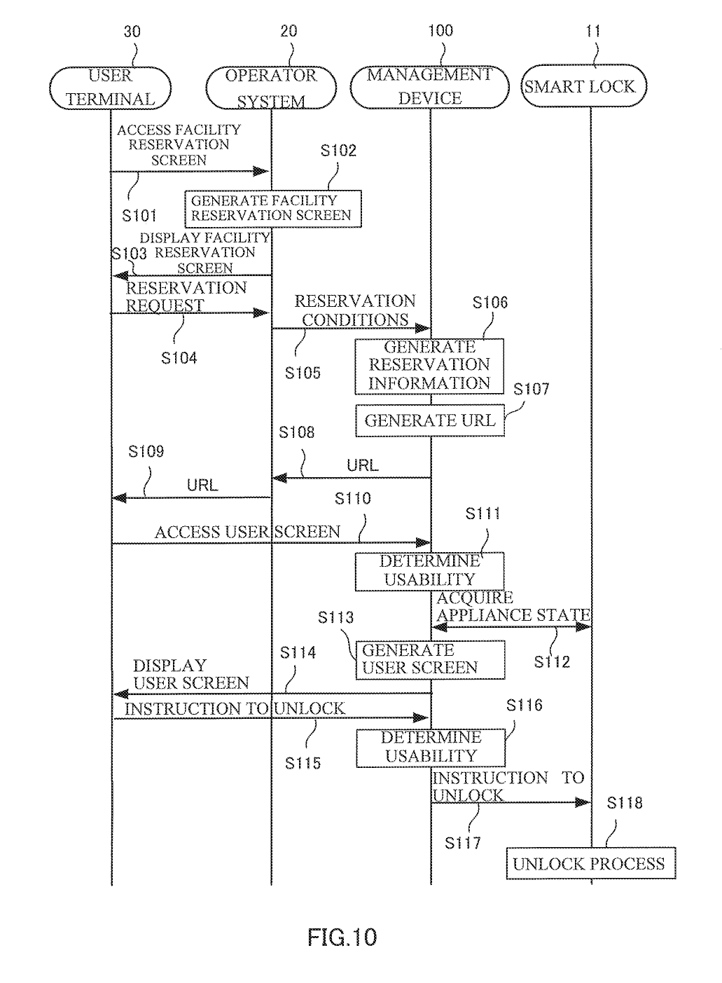

FIG. 10 is a sequence diagram for describing facility reservation and unlock operations of management system 1. User terminal 30 accesses a facility reservation screen of operator system 20 (step S101). Operator system 20 generates a facility reservation screen including information about a facility which can be currently reserved (step S102), and displays the facility reservation screen (step S103). User terminal 30 operates the displayed facility reservation screen, and transmits, to operator system 20, a reservation request including a reservation target facility and reservation time information (step S104). Based on input information from user terminal 30, operator system 20 transmits, to management device 100, reservation conditions including a lock ID of smart lock 11 installed at the reservation target facility and the reservation time information (step S105).

When the reservation conditions are received from operator system 20, management device 100 generates reservation information for smart lock 11 based on the received reservation conditions, and causes the generated reservation information to be stored in reservation database 102. Specifically, reservation receiver 103 of management device 100 assigns a reservation ID for identifying each reservation, based on the reservation conditions, and causes the reservation information to be stored in reservation database 102 (step S106).

After generating the reservation information, reservation receiver 103 of management device 100 generates an URL corresponding to the generated reservation information (step S107). This URL is an example of access information which is generated in correspondence with each piece of reservation information, and which is used to access an operation screen for operating smart lock 11 installed at the reservation target facility. Reservation receiver 103 outputs the generated URL to operator system 20 (step S108).

When the URL for accessing the user screen is received from management device 100, operator system 20 transmits the URL to user terminal 30. For example, operator system 20 generates an email including the URL, and transmits the email to user terminal 30 (step S109). The user of user terminal 30 accesses the user screen by operating the URL included in the received email (step S110).

When access to the user screen is received, usability determiner 104 of management device 100 determines usability. Specifically, usability determiner 104 determines usability based on whether a current time is included in the reservation time in the reservation information associated with the URL (step S111).

Usability determiner 104 acquires the state of smart lock 11 corresponding to the reservation information. For example, the state of smart lock 11 is an open/close state of smart lock 11 (step S112). Usability determiner 104 generates the user screen by using a determination result regarding usability and the acquired open/close state of smart lock 11 (step S113). Usability determiner 104 causes the generated user screen to be displayed by user terminal 30 (step S114).

For example, the user screen includes the reservation information, the operation button for operating target smart lock 11, and the open/close state of smart lock 11. In the case where the current time is not yet the reservation time, usability determiner 104 does not display the operation button on the user screen, or may display the operation button in a state where the operation button cannot be operated. The user of user terminal 30 may issue an instruction to unlock, by using the operation button on the user screen (step S115).

When the unlock instruction are received, usability determiner 104 again determines usability. Specifically, usability determiner 104 determines usability based on whether the current time is included in the reservation time in the reservation information associated with the URL. When there is a lapse of time between display of the user screen and operation on the user screen, usability is possibly changed, and usability determiner 104 determines usability again before operation of smart lock 11 (step S116).

When it is determined that use is allowed, usability determiner 104 inputs an unlock instruction to appliance controller 105, and appliance controller 105 instructs smart lock 11 to unlock (step S117). Smart lock 11 performs an unlock process under the control of management device 100 (step S118).

(Management Operation)

FIG. 7 is a sequence diagram for describing an operation related to a manager screen provided by management device 100 of management system 1.

An operator performs, from a terminal which is connected to operator system 20, an access request for the management screen by using the operator ID (step S201). In response to the access request, management operation receiver 106 of management device 100 acquires a facility name which is associated with the operator ID from appliance database 101, and generates the management screen (step S202). The facility name acquired from appliance database 101 is displayed in a building list on the management screens in FIGS. 7 and 8. Management operation receiver 106 causes the generated management screen to be displayed by the terminal of operator system 20 (step S203). The operator selects a specific facility from the building list on the management screen (step S204).

Management operation receiver 106 of management device 100 acquires, from reservation database 102, the reservation information which is associated with the lock ID of the selected facility (step S205). Management operation receiver 106 acquires an appliance state of smart lock 11 which is identified by the lock ID (step S206). Management operation receiver 106 updates the management screen by using the reservation information and appliance state which are acquired. Specifically, management operation receiver 106 causes the state of door lock, door lock operation, a reservation list and the like displayed on the right side in FIG. 5 to be displayed on the management screen (step S207).

The operator may issue, from the management screen, an instruction to lock smart lock 11 installed at the selected facility (step S208). When an instruction to lock is issued, management operation receiver 106 of management device 100 inputs the lock ID and the instruction to lock to appliance controller 105, and appliance controller 105 instructs smart lock 11 to lock (step S209). Smart lock 11 performs a lock process under the control of management device 100 (step S210).

As described above, according to the first embodiment of the present invention, authorization to operate network appliance 10, or smart lock 11 in particular, may be temporarily provided. As a method of temporarily providing authorization to operate smart lock 11, issuance of a temporal key enabling operation of smart lock 11 by near field wireless communication to user terminal 30 is possible, in addition to the present embodiment. However, with the present embodiment, management device 100 itself operates smart lock 11, and the security is increased. Furthermore, smart lock 11 can be operated regardless of where the user is, and thus, a plurality of smart locks 11 can be controlled at once, and the possibility that various services can use the function is opened up. For example, in a case where a cleaning service is hired to clean a plurality of meeting rooms in one building, it is desirable to provide the cleaning service with authorization to open/close the keys of the plurality of meeting rooms only for a specific period of time (such as 18:00 to 19:00, Monday to Friday) specified in the contract. In this case, usability determiner 104 may provide a user screen allowing operation of a plurality of smart locks 11. This user screen may include a collective operation button for opening/closing the plurality of smart locks 11 at once. When an instruction to unlock or lock smart locks 11 is issued by the collective operation button, appliance controller 105 simultaneously instructs the plurality of smart locks 11 to unlock or lock.

Furthermore, according to the embodiment described above, an API for allowing network appliance 10, such as smart lock 11, to coordinate with an external system is provided, and thus, the time and cost for system construction can be greatly reduced compared to a case where a system for controlling each network appliance 10 is constructed from scratch. Accordingly, various services that use network appliance 10 can be easily and safely provided.

### Second Embodiment

(Configuration of Management Device 200)

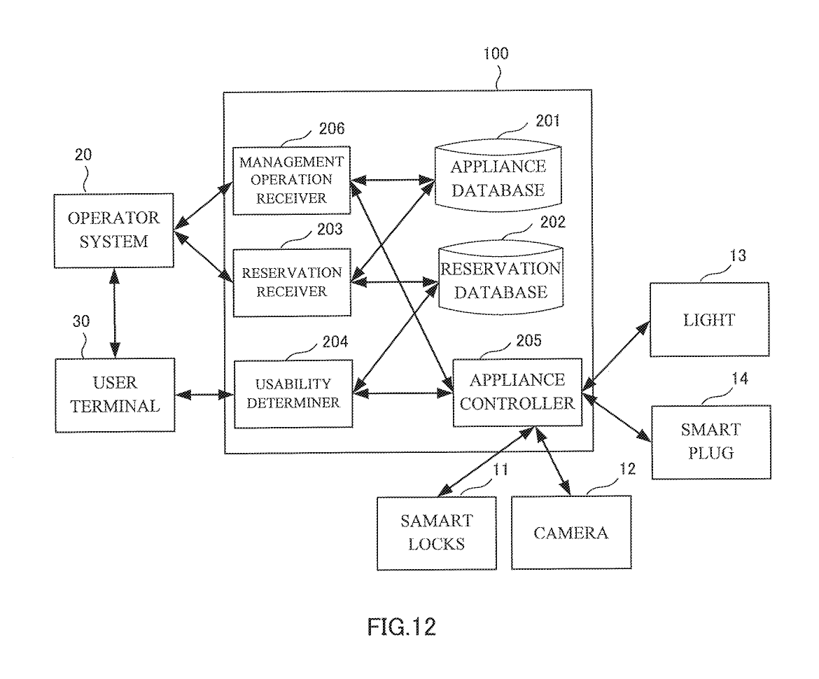

FIG. 12 is a diagram showing a configuration of management device 200 according to a second embodiment of the present invention. Also in the present embodiment, as in the first embodiment, management device 200 may receive reservation information from operator system 20, and may temporarily provide authorization to operate network appliance 10, based on the reservation information. In the first embodiment, network appliance 10 is smart lock 11, but in the present embodiment, network appliance 10 includes smart lock 11, camera 12, light 13, and smart plug 14. In the following, a difference to the first embodiment will be mainly described, and a description of aspects the same as those of the first embodiment will be omitted.

Management device 200 includes appliance database 201, reservation database 202, reservation receiver 203, usability determiner 204, appliance controller 205, and management operation receiver 206. For the sake of simplicity, FIG. 12 shows one smart lock 11, one camera 12, one light 13, one smart plug 14, one operator system 20, and one user terminal 30. However, management device 100 may connect, through the Internet, to a plurality of smart locks 11, a plurality of cameras 12, a plurality of lights 13, a plurality of smart plugs 14, a plurality of operator systems 20, and a plurality of user terminals 30.

In the present embodiment, network appliances 10 other than smart lock 11, that is, camera 12, light 13, and smart plug 14 are installed at a facility where smart lock 11 is installed. Camera 12, light 13, and smart plug 14 may be installed at a common space of the facility where smart lock 11 is installed, or may be installed in a room of the facility where smart lock 11 is installed. Like smart lock 11, camera 12, light 13, and smart plug 14 may operate according to an instruction from appliance controller 205 of management device 200.

Camera 12 may acquire an image, such as a still image or a moving image, and may transmit the acquired image to management device 200. Light 13 illuminates the surroundings of an installation position by being turned on. Light 13 is electrically controlled through a communication network to be turned on or off. Smart plug 14 includes a connector for connecting an electronic appliance, and supplies power to the connected electronic appliance. Smart plug 14 is electrically controlled through the communication network, and is switched between a state of supplying power to the connected electronic appliance and a state where power is cut off.

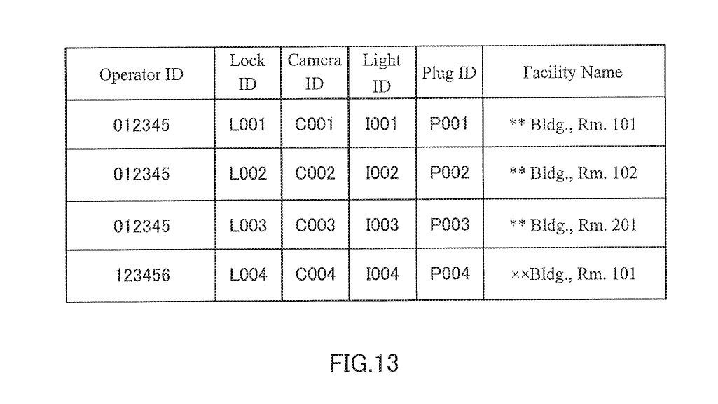

Appliance database 201 stores, for each facility where network appliance 10 is installed, information about an operator operating operator system 20 and network appliance 10 which is associated with the operator. FIG. 13 shows an example of information which is stored in appliance database 201. Appliance database 201 includes an operator ID, which is an identifier for identifying the operator, and an identifier for identifying network appliance 10. The identifier for identifying network appliance 10 includes a lock ID for identifying smart lock 11, a camera ID for identifying camera 12, a light ID for identifying light 13, and a plug ID for identifying smart plug 14. Appliance database 201 may further include the name of a facility where each network appliance 10 is installed.

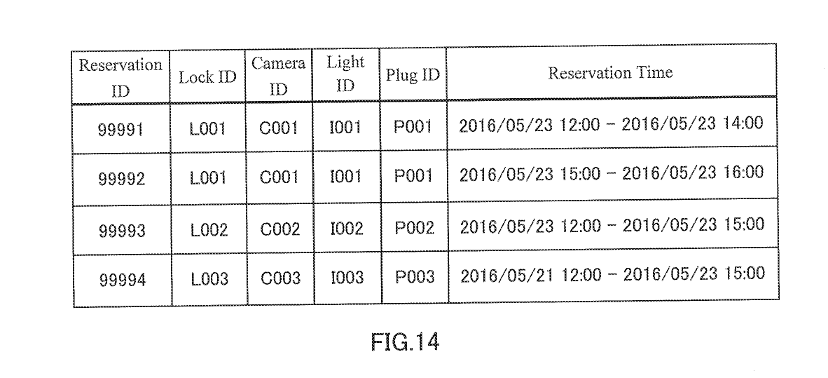

Reservation database 202 stores reservation information which is generated based on reservation conditions including the identifier for identifying network appliance 10 and reservation time information which are received from operator system 20. FIG. 14 is an example of the reservation information which is stored in reservation database 202. In this example, the reservation information includes a reservation ID, the lock ID, the camera ID, the light ID, the plug ID, and a reservation time. Additionally, in this example, the lock IDs, the camera IDs, the light IDs, and the plug IDs associated with all the reservation IDs are included, but in the case where corresponding network appliance 10 in not installed in the reservation target facility, the reservation information does not include the identification information of network appliance 10 which is not installed.

Reservation receiver 203 generates reservation information about control of network appliance 10 based on the reservation conditions received from operator system 20, and causes the reservation information to be stored in reservation database 202. Reservation receiver 203 generates an URL, which is address information for accessing a user screen corresponding to the generated reservation information, and outputs the generated URL to operator system 20. The user screen is an operation screen which a user of user terminal 30 uses to operate network appliance 10.

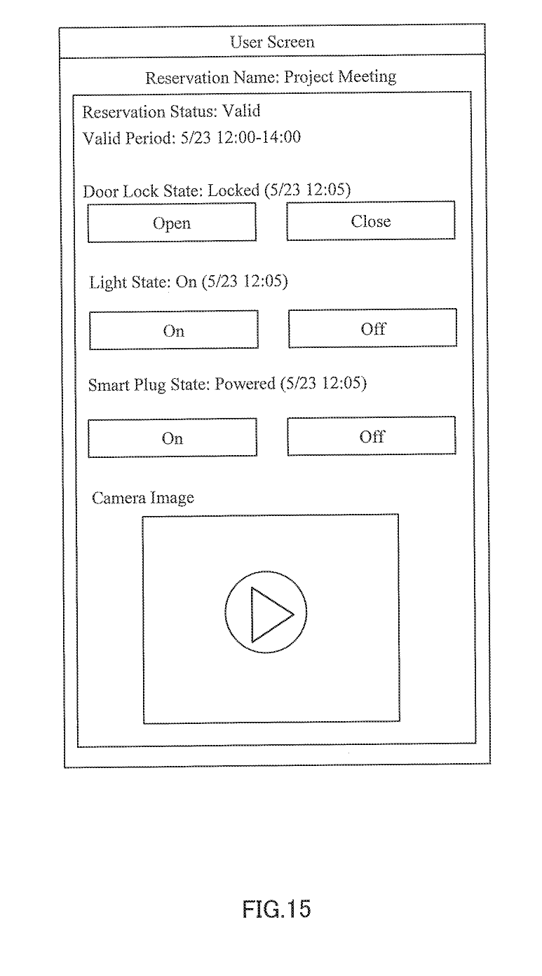

Usability determiner 204 receives access which is based on the URL output from reservation receiver 203, and determines usability of network appliance 10 based on the reservation information stored in reservation database 202. Usability determiner 204 generates the user screen based on a determination result regarding usability, and causes the generated user screen to be displayed by user terminal 30. FIG. 15 shows an example of the user screen for operating network appliance 10. The user screen includes an “open” button and a “close” button for operating opening/closing of smart lock 11, and an “on” button and an “off” button for switching an illumination state of light 13. The user screen in FIG. 15 includes an “on” button and an “off” button for switching a power supply state of smart plug 14, and a replay button for operating camera 12. In the example in FIG. 15, a camera image is not displayed in a state where the user screen is first displayed, but the user screen may include a latest still image of camera 12 at the time of display of the user screen, for example. When the replay button is operated, the user screen displays a moving image of camera 12. When an operation instruction for smart lock 11, camera 12, light 13, or smart plug 14 is received from user terminal 30 through the user screen, usability determiner 204 again determines the usability. In the case of determining that use is allowed, usability determiner 204 instructs appliance controller 205 to control smart lock 11, camera 12, light 13, or smart plug 14.

Appliance controller 205 controls smart lock 11, camera 12, light 13, or smart plug 14 based on the instruction from usability determiner 204. Moreover, appliance controller 205 may also control smart lock 11, camera 12, light 13, or smart plug 14 based on an instruction from management operation receiver 206.

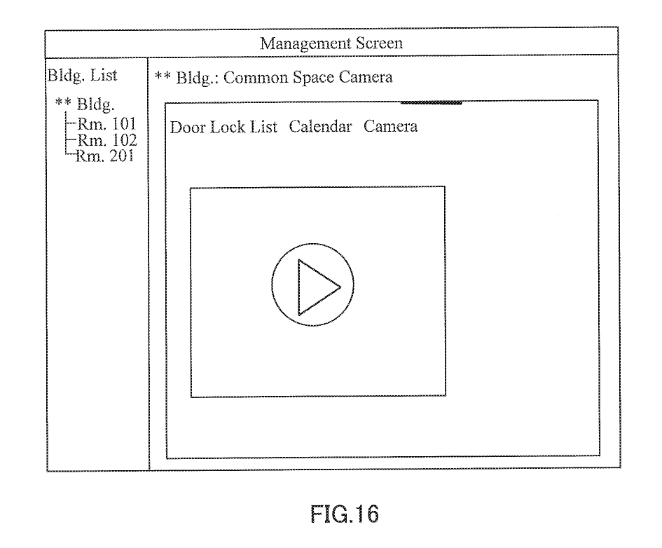

Management operation receiver 206 generates and outputs a management screen which is used by the operator operating operator system 20 to manage network appliance 10. Management operation receiver 206 is capable of generating a management screen for allowing operation of camera 12, light 13, or smart plug 14, in addition to the management screens shown in FIGS. 7 and 8. FIG. 16 shows an example of a management screen allowing operation of camera 12. This management screen includes the replay button for operating camera 12. As in the case of the user screen, the management screen may include a latest still image of camera 12 in a state where the management screen is first displayed. When the replay button is operated, the management screen displays a moving image of camera 12.

### Third Embodiment

Management device 100 according to the first embodiment controls smart lock 11, and management device 200 according to the second embodiment controls network appliances 10 such as camera 12, light 13, and smart plug 14, in addition to smart lock 11. In contrast, management device 300 according to a third embodiment of the present invention is capable of controlling camera 12, instead of smart lock 11. In this case, camera 12 may be installed at any location indoor and outdoor, without being restricted to a facility where smart lock 11 is installed.

A functional configuration of management device 300 is the same as that described with respect to management device 100 according to the first embodiment, except that smart lock 11 is replaced by camera 12, and a description thereof is omitted.

<Hardware Configuration>

Examples of the functions of management devices 100, 200, 300 are described above using the first to the third embodiments. Each structural element described above may be configured by using a general-purpose member, a circuit and the like, or may be configured by hardware dedicated to the function of each structural element. Furthermore, each structural element described above may be configured by using a plurality of devices connected through a network, or a plurality of structural elements may be configured by one piece of hardware.

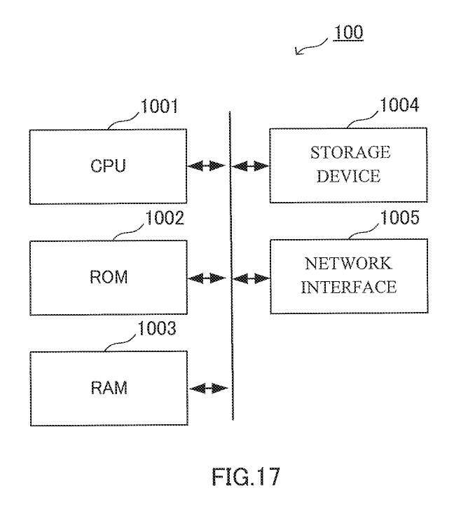

FIG. 17 shows an example hardware configuration of management device 100 according to the first embodiment of the present invention. Management device 100 includes central processing unit (CPU) 1001, read only memory (ROM) 1002, and random access memory (RAM) 1003. Management device 100 may be configured by a computer further including storage device 1004, and network interface 1005. CPU 1001 is an example of an arithmetic device, and ROM 1002 and RAM 1003 are examples of a storage medium. Storage device 1004 is a device for storing data, and may include a storage medium, a recording device for recording data in the storage medium, a reading device for reading data from the storage medium, a delete device for deleting data recorded in the storage medium, and the like. As the storage medium, a non-volatile memory such as a flash memory, a magnetic recording medium such as a hard disk, and the like may be used.

Computer programs describing procedures for realizing the functions of management device 100, and various pieces of data necessary to execute the programs are stored in ROM 1002 or storage device 1004. CPU 1001 loads the computer program and the various pieces of data into RAM 1003, and executes the computer program by using storage device 1004 and network interface 1005, and each function of management device 100 is thereby realized. An example of hardware configuration of management device 100 is described above, but the same can be said for the hardware configurations of management devices 200 and 300.

Heretofore, the invention of the present application has been described with reference to the embodiments, but the invention of the present application is not limited to the embodiments described above. Various changes understandable to those skilled in the art can be made to the configurations and specifics of the invention of the present application within the scope of the technical idea of the invention of the present application.

For example, although a method used by management device 100 to control each network appliance 10 is not described in detail in the embodiment described above, management device 100 may further use an API for controlling each network appliance 10 to control network appliance 10. That is, an API for using management device 100 may further use another API.

In the second embodiment described above, camera 12 can be controlled from the user screen, but the present invention is not limited to such an example. For example, even if camera 12 is installed at a target facility, control from the user screen does not necessarily have to be allowed, and depending on the contents of services provided by an operator, camera 12 may be controlled only from the management screen. The same can be said for network appliances 10 other than camera 12.

Moreover, in the second embodiment described above, smart plug 14 can be controlled from the user screen, but the present invention is not limited to such an example. For example, smart plug 14 may be controlled by management device 200 based on the reservation information. In this case, management device 200 may supply power to smart plug 14 only during a period of time when the reservation is valid. Alternatively, management device 200 may control smart plug 14 based on an open/close state of smart lock 11 which is installed in the same facility as smart plug 14.

In the third embodiment described above, network appliance 10 is camera 12, but the present invention is not limited to such an example. Also with respect to network appliances 10 other than camera 12, services that allow a user to use network appliances 10 for a specific period of time can be provided in the same manner.

Additionally, a method of controlling an information processing apparatus for realizing the functions of management device 100 according to the present embodiment described above may also be provided. Furthermore, to realize each function of management device 100, a computer program for causing a computer to execute each step of the control method described above may be generated and installed in a personal computer or the like. A computer-readable recording medium storing such a computer program may also be provided. The recording medium is a magnetic disk, an optical disk, a magneto-optical disk, a flash memory, or the like. Moreover, the computer program described above may be distributed over a communication network or the like, without using a recording medium.

### REFERENCE SIGNS LIST

1 management system
10 network appliance
11 smart lock
100 management device
101 appliance database
102 reservation database
103 reservation receiver
104 usability determiner
105 appliance controller
106 management operation receiver
20 operator system
30 user terminal

1. A management device comprising:
a reservation receiver that receives reservation conditions including an identifier for identifying a network appliance that can be electrically controlled through a communication network and reservation time information indicating a time of controlling the network appliance, that generates reservation information based on the reservation conditions, and that outputs address information for accessing a user screen corresponding to the reservation information that is generated;
a usability determiner that determines usability of the network appliance based on the reservation information, when an instruction to operate the network appliance is issued from the user screen that is accessed by using the address information; and
an appliance controller that controls the network appliance based on the instruction, in a case where said usability determiner determines that the network appliance is usable.

2. The management device according to claim 1, further comprising:
an appliance database that stores appliance information indicating a correspondence relationship between identification information of a plurality of the network appliances and identification information of a manager of respective network appliances; and
a management operation receiver that outputs, when the identification information of the manager is received, a management screen for managing the network appliance that is associated with the identification information of the manager.

3. The management device according to claim 2, wherein in a case where an instruction to operate the network appliance is issued from the management screen, said management operation receiver controls the network appliance based on the instruction.

4. The management device according to claim 2, wherein when the network appliance is specified on the management screen, said management operation receiver causes the reservation information of the network appliance that is specified to be displayed on the management screen.

5. The management device according to claim 2, wherein said management operation receiver further includes a function of generating the reservation information based on reservation conditions input on the management screen, and after generating the reservation information, said management operation receiver outputs address information for accessing a user registration screen that is used for registration of identification information and a password of a user who is associated with the reservation information.

6. The management device according to claim 5, wherein in a case where a plurality of pieces of the reservation information are associated with the identification information of the user who is registered, said usability determiner generates and outputs the user screen for receiving operation of the network appliance corresponding to the plurality of pieces of the reservation information.

7. The management device according to claim 1, wherein
the network appliance includes a smart lock, opening and closing of which can be electrically controlled through the communication network,
said reservation receiver generates the reservation information including identifiers of a plurality of the smart locks, in a case where the reservation conditions including the identifiers of the plurality of smart locks and reservation time information for a facility where the plurality of smart locks are installed are received, and
said usability determiner generates and outputs the user screen for operating the plurality of smart locks corresponding to the reservation information.

8. The management device according to claim 7, wherein
said usability determiner generates and outputs a user screen including a collective operation button for collectively operating the plurality of smart locks corresponding to the reservation information, and
said appliance controller instructs, at one time, the plurality of smart locks to unlock or lock, in a case where an operation of the collective operation button is received.

9. The management device according to claim 1, wherein in a case where one piece of reservation information includes identifiers for identifying network appliances of a plurality of types, said usability determiner causes the user screen including an operation unit for issuing an instruction regarding operation of the network appliances of the plurality of types to be displayed.

10. A control method comprising the steps of:
receiving reservation conditions including an identifier for identifying a network appliance that can be electrically controlled through a communication network and reservation time information indicating a time of controlling the network appliance, and generating reservation information based on the reservation conditions;
outputting address information for accessing a user screen corresponding to the reservation information that is generated;
determining usability of the network appliance based on the reservation information, when an instruction to operate the network appliance is issued from the user screen that is accessed by using the address information; and
controlling the network appliance based on the instruction, in a case where the network appliance is determined to be usable.

11. A program for causing a computer to perform the steps of:
receiving reservation conditions including an identifier for identifying a network appliance that can be electrically controlled through a communication network and reservation time information indicating a time of controlling the network appliance, and generating reservation information based on the reservation conditions;
outputting address information for accessing a user screen corresponding to the reservation information that is generated;
determining usability of the network appliance based on the reservation information, when an instruction to operate the network appliance is issued from the user screen that is accessed by using the address information; and
controlling the network appliance based on the instruction, in a case where the network appliance is determined to be usable.
